(19) United States
(12) Patent Application Publication
(10) Pub. No.: US 2019/0122693 A1
(43) Pub. Date: Apr. 25, 2019

(54) System and Method for Analyzing Audio Information to Determine Pitch and/or Fractional Chirp Rate

(71) Applicant: Friday Harbor LLC, New York, NY (US)

(72) Inventors: David C. Bradley, La Jolla, CA (US); Nicholas K. Fisher, San Diego, CA (US); Robert N. Hilton, San Diego, CA (US); Rodney Gateau, San Diego, CA (US); Derrick R. Roos, San Diego, CA (US)

(21) Appl. No.: 15/962,863

(22) Filed: Apr. 25, 2018

Related U.S. Application Data
(63) Continuation of application No. 13/205,455, filed on Aug. 8, 2011, now abandoned.

(51) Int. Cl. G10L 25/90

(52) U.S. Cl. CPC G10L 25/90

(57) ABSTRACT

A system and method may be configured to analyze audio information. The system and method may include determining for an audio signal, an estimated pitch of a sound represented in the audio signal, an estimated chirp rate (or fractional chirp rate) of a sound represented in the audio signal, and/or other parameters of sound(s) represented in the audio signal. The one or more parameters may be determined through analysis of transformed audio information derived from the audio signal (e.g., through Fourier Transform, Fast Fourier Transform, Short Time Fourier Transform, Spectral Motion Transform, and/or other transforms). Statistical analysis may be implemented to determine metrics related to the likelihood that a sound represented in the audio signal has a pitch and/or chirp rate (or fractional chirp rate). Such metrics may be implemented to determine an estimated pitch and/or fractional chirp rate.

### FIELD

The invention relates to analyzing audio information to determine the pitch and/or fractional chirp rate of a sound within a time sample window of the audio information by determining a tone likelihood metric and a pitch likelihood metric from a transformation of the audio information for the time sample window.

### BACKGROUND

Systems and methods for analyzing transformed audio information to detect pitch of sounds represented in the transformed audio information are known. Generally, these techniques focus on analyzing either transformed audio information or a further transformation of previously transformed audio information (e.g., the cepstrum), and comparing amplitude peaks with a threshold to identify tones represented in the transformed audio information. From the identified tones, a estimation of pitch may be made.

These techniques operate with relative accuracy and precision in the best of conditions. However, in “noisy” conditions (e.g., either sound noise or processing noise) the accuracy and/or precision of conventional techniques may drop off significantly. Since many of the settings and/or audio signals in and on which these techniques are applied may be considered noisy, conventional processing to detect pitch may be only marginally useful.

### SUMMARY

One aspect of the disclosure relates to a system and method of analyzing audio information. The system and method may include determining for an audio signal, an estimated pitch of a sound represented in the audio signal, an estimated chirp rate (or fractional chirp rate) of a sound represented in the audio signal, and/or other parameters of sound(s) represented in the audio signal. The one or more parameters may be determined through analysis of transformed audio information derived from the audio signal (e.g., through Fourier Transform, Fast Fourier Transform, Short Time Fourier Transform, Spectral Motion Transform, and/or other transforms). Statistical analysis may be implemented to determine metrics related to the likelihood that a sound represented in the audio signal has a pitch and/or chirp rate (or fractional chirp rate). Such metrics may be implemented to estimate pitch and/or fractional chirp rate.

In some implementations, a system may be configured to analyze audio information. The system may comprise one or more processors configured to execute computer program modules. The computer program modules may comprise one or more of an audio information module, a tone likelihood module, a pitch likelihood module, an estimated pitch module, and/or other modules.

The audio information module may be configured to obtain transformed audio information representing one or more sounds. The transformed audio information may specify magnitude of a coefficient related to signal intensity as a function of frequency for an audio signal within a time sample window. In some implementations, the transformed audio information for the time sample window may include a plurality of sets of transformed audio information. The individual sets of transformed audio information may correspond to different fractional chirp rates. Obtaining the transformed audio information may include transforming the audio signal, receiving the transformed audio information in a communications transmission, accessing stored transformed audio information, and/or other techniques for obtaining information.

The tone likelihood module may be configured to determine, from the obtained transformed audio information, a tone likelihood metric as a function of frequency for the audio signal within the time sample window. The tone likelihood metric for a given frequency may indicate the likelihood that a sound represented by the audio signal has a tone at the given frequency during the time sample window. The tone likelihood module may be configured such that the tone likelihood metric for a given frequency is determined based on a correlation between (i) a peak function having a function width and being centered on the given frequency and (ii) the transformed audio information over the function width centered on the given frequency. The peak function may include a Gaussian function, and/or other functions.

The pitch likelihood module may be configured to determine, based on the tone likelihood metric, a pitch likelihood metric as a function of pitch for the audio signal within the time sample window. The pitch likelihood metric for a given pitch may be related to the likelihood that a sound represented by the audio signal has the given pitch. The pitch likelihood module may be configured such that the pitch likelihood metric for the given pitch is determined by aggregating the tone likelihood metric determined for the tones that correspond to the harmonics of the given pitch.

In some implementations, the pitch likelihood module may comprise a logarithm sub-module, a sum sub-module, and/or other sub-modules. The logarithm sub-module may be configured to take the logarithm of the tone likelihood metric to determine the logarithm of the tone likelihood metric as a function of frequency. The sum sub-module may be configured to determine the pitch likelihood metric for individual pitches by summing the logarithm of the tone likelihood metrics that correspond to the individual pitches.

The estimated pitch module may be configured to determine an estimated pitch of a sound represented in the audio signal within the time sample window based on the pitch likelihood metric. Determining the estimated pitch may include identifying a pitch for which the pitch likelihood metric has a maximum within the time sample window. In some implementations in which the transformed audio information includes a plurality of sets of transformed audio information that correspond to separate fractional chirp rates, the pitch likelihood metric may be determined separately within the individual sets of transformed audio information to determine the pitch likelihood metric for the audio signal within the time sample window as a function of pitch and fractional chirp rate. In such implementations, the estimated pitch module may be configured to determine an estimated pitch and an estimated fractional chirp rate from the pitch likelihood metric. This may include identifying a pitch and chirp rate for which the pitch likelihood metric has a maximum within the time sample window.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to analyze audio information.

FIG. 2 illustrates a plot of transformed audio information.

FIG. 3 illustrates a plot of a tone likelihood metric versus frequency.

FIG. 4 illustrates a plot of a pitch likelihood metric versus pitch.

FIG. 5 illustrates a plot of pitch likelihood metric as a function of pitch and fractional chirp rate.

FIG. 6 illustrates a method of analyzing audio information.

### DETAILED DESCRIPTION

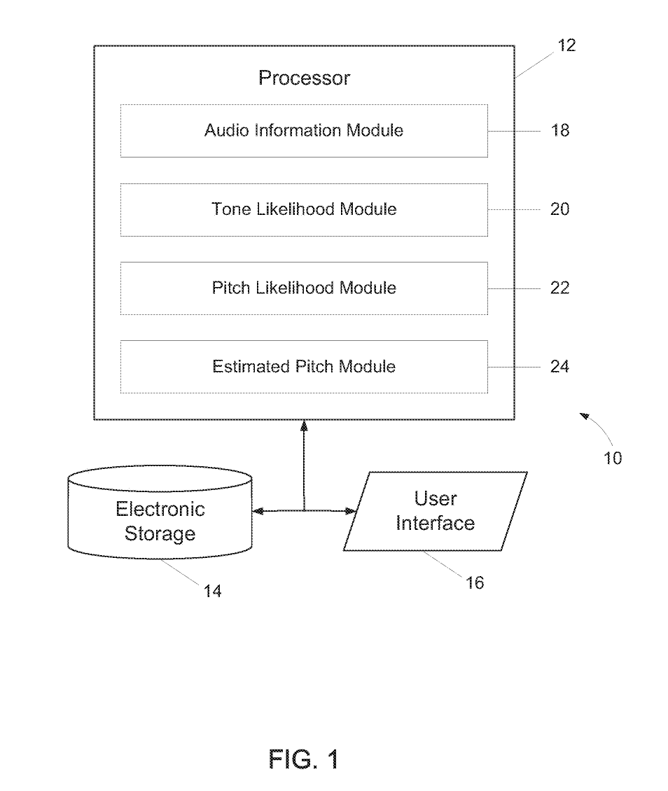

FIG. 1 illustrates a system 10 configured to analyze audio information. The system 10 may be configured to determine for an audio signal, an estimated pitch of a sound represented in the audio signal, an estimated chirp rate (or fractional chirp rate) of a sound represented in the audio signal, and/or other parameters of sound(s) represented in the audio signal. The system 10 may be configured to implement statistical analysis that provides metrics related to the likelihood that a sound represented in the audio signal has a pitch and/or chirp rate (or fractional chirp rate).

The system 10 may be implemented in an overarching system (not shown) configured to process the audio signal. For example, the overarching system may be configured to segment sounds represented in the audio signal (e.g., divide sounds into groups corresponding to different sources, such as human speakers, within the audio signal), classify sounds represented in the audio signal (e.g., attribute sounds to specific sources, such as specific human speakers), reconstruct sounds represented in the audio signal, and/or process the audio signal in other ways. In some implementations, system 10 may include one or more of one or more processors 12, electronic storage 14, a user interface 16, and/or other components.

The processor 12 may be configured to execute one or more computer program modules. The computer program modules may be configured to execute the computer program module(s) by software; hardware; firmware; some combination of software, hardware, and/or firmware; and/or other mechanisms for configuring processing capabilities on processor 12. In some implementations, the one or more computer program modules may include one or more of an audio information module 18, a tone likelihood module 20, a pitch likelihood module 22, an estimated pitch module 24, and/or other modules.

The audio information module 18 may be configured to obtain transformed audio information representing one or more sounds. The transformed audio information may include a transformation of an audio signal into the frequency domain (or a pseudo-frequency domain) such as a Discrete Fourier Transform, a Fast Fourier Transform, a Short Time Fourier Transform, and/or other transforms. The transformed audio information may include a transformation of an audio signal into a frequency-chirp domain, as described, for example, in U.S. patent application Ser. No. [Attorney Docket 073968-0396431], filed Aug. 8, 2011, and entitled “System And Method For Processing Sound Signals Implementing A Spectral Motion Transform” (“the 'XXX Application”) which is hereby incorporated into this disclosure by reference in its entirety. The transformed audio information may have been transformed in discrete time sample windows over the audio signal. The time sample windows may be overlapping or non-overlapping in time. Generally, the transformed audio information may specify magnitude of a coefficient related to signal intensity as a function of frequency (and/or other parameters) for an audio signal within a time sample window.

By way of non-limiting example, a time sample window may correspond to a Gaussian envelope function with standard deviation 20 msec, spanning a total of six standard deviations (120 msec), and/or other amounts of time.

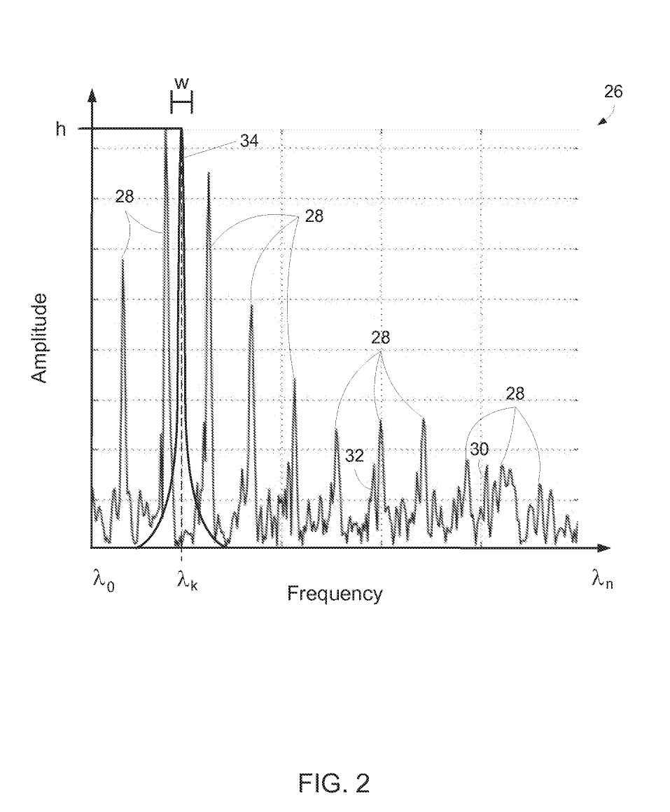

By way of illustration, FIG. 2 depicts a plot 26 of transformed audio information. The plot 26 may be in a space that shows a magnitude of a coefficient related to signal intensity as a function of frequency. The transformed audio information represented by plot 26 may include a harmonic sound, represented by a series of spikes 28 in the magnitude of the coefficient at the frequencies of the harmonics of the harmonic sound. Assuming that the sound is harmonic, spikes 28 may be spaced apart at intervals that correspond to the pitch (ϕ) of the harmonic sound. As such, individual spikes 28 may correspond to individual ones of the overtones of the harmonic sound.

Other spikes (e.g., spikes 30 and/or 32) may be present in the transformed audio information. These spikes may not be associated with harmonic sound corresponding to spikes 28. The difference between spikes 28 and spike(s) 30 and/or 32 may not be amplitude, but instead frequency, as spike(s) 30 and/or 32 may not be at a harmonic frequency of the harmonic sound. As such, these spikes 30 and/or 32, and the rest of the amplitude between spikes 28 may be a manifestation of noise in the audio signal. As used in this instance, “noise” may not refer to a single auditory noise, but instead to sound (whether or not such sound is harmonic, diffuse, white, or of some other type) other than the harmonic sound associated with spikes 28.

The transformation that yields the transformed audio information from the audio signal may result in the coefficient related to energy being a complex number. The transformation may include an operation to make the complex number a real number. This may include, for example, taking the square of the argument of the complex number, and/or other operations for making the complex number a real number. In some implementations, the complex number for the coefficient generated by the transform may be preserved. In such implementations, for example, the real and imaginary portions of the coefficient may be analyzed separately, at least at first. By way of illustration, plot 26 may represent the real portion of the coefficient, and a separate plot (not shown) may represent the imaginary portion of the coefficient as a function of frequency. The plot representing the imaginary portion of the coefficient as a function of frequency may have spikes at the harmonics of the harmonic sound that corresponds to spikes 28.

In some implementations, the transformed audio information may represent all of the energy present in the audio signal, or a portion of the energy present in the audio signal. For example, if the transformed audio signal places the audio signal in the frequency-chirp domain, the coefficient related to energy may be specified as a function of frequency and fractional chirp rate (e.g., as described in the 'XXX Application). In such examples, the transformed audio information may include a representation of the energy present in the audio signal having a common fractional chirp rate (e.g., a two-dimensional slice through the three-dimensional chirp space along a single fractional chirp rate).

Referring back to FIG. 1, tone likelihood module 20 may be configured to determine, from the obtained transformed audio information, a tone likelihood metric as a function of frequency for the audio signal within a time sample window. The tone likelihood metric for a given frequency may indicate the likelihood that a sound represented by the transformed audio information has a tone at the given frequency during the time sample window. A “tone” as used herein may refer to a harmonic (or overtone) of a harmonic sound, or a tone of a non-harmonic sound.

Referring back to FIG. 2, in plot 26 of the transformed audio information, a tone may be represented by a spike in the coefficient, such as any one of spikes 28, 30, and/or 32. As such, a tone likelihood metric for a given frequency may indicate the likelihood of a spike in plot 26 at the given frequency that represents a tone in the audio signal at the given frequency within the time sample window corresponding to plot 26.

Determination of the tone likelihood metric for a given frequency may be based on a correlation between the transformed audio information at and/or near the given frequency and a peak function having its center at the given frequency. The peak function may include a Gaussian peak function, a χ² distribution, and/or other functions. The correlation may include determination of the dot product of the normalized peak function and the normalized transformed audio information at and/or near the given frequency. The dot product may be multiplied by −1, to indicate a likelihood of a peak centered on the given frequency, as the dot product alone may indicate a likelihood that a peak centered on the given frequency does not exist.

By way of illustration, FIG. 2 further shows an exemplary peak function 34. The peak function 34 may be centered on a central frequency λₖ. The peak function 34 may have a peak height (h) and/or width (w). The peak height and/or width may by parameters of the determination of the tone likelihood metric. To determine the tone likelihood metric, the central frequency may be moved along the frequency of the transformed audio information from some initial central frequency λ₀, to some final central frequency λₙ. The increment by which the central frequency of peak function 34 is moved between the initial central frequency and the final central frequency may be a parameter of the determination. One or more of the peak height, the peak width, the initial central frequency, the final central frequency, the increment of movement of the central frequency, and/or other parameters of the determination may be fixed, set based on user input, tune (e.g., automatically and/or manually) based on the expected width of peaks in the transformed audio data, the range of tone frequencies being considered, the spacing of frequencies in the transformed audio data, and/or set in other ways.

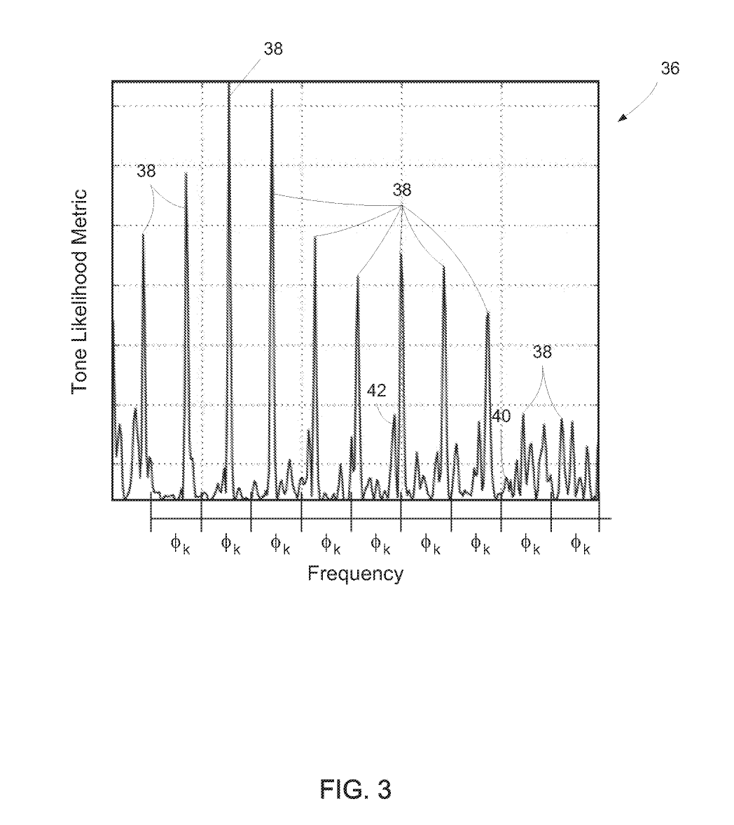

Determination of the tone likelihood metric as a function of frequency may result in the creation of a new representation of the data that expresses a tone likelihood metric as a function of frequency. By way of illustration, FIG. 3 illustrates a plot 36 of the tone likelihood metric for the transformed audio information shown in FIG. 2 as a function of frequency. As can be seen in FIG. 3 may include spikes 38 corresponding to spikes 28 in FIG. 2, and FIG. 3 may include spikes 40 and 42 corresponding to spikes 30 and 32, respectively, in FIG. 2. In some implementations, the magnitude of the tone likelihood metric for a given frequency may not correspond to the amplitude of the coefficient related to energy for the given frequency specified by the transformed audio information. Instead, the tone likelihood metric may indicate the likelihood of a tone being present at the given frequency based on the correlation between the transformed audio information at and/or near the given frequency and the peak function. Stated differently, the tone likelihood metric may correspond more to the salience of a peak in the transformed audio data than to the size of that peak.

Referring back to FIG. 1, in implementations in which the coefficient representing energy is a complex number, and the real and imaginary portions of the coefficient are processed separately by tone likelihood module 20 as described above with respect to FIGS. 2 and 3, tone likelihood module 20 may determine the tone likelihood metric by aggregating a real tone likelihood metric determined for the real portions of the coefficient and an imaginary tone likelihood metric determined for the imaginary portions of the coefficient (both the real and imaginary tone likelihood metrics may be real numbers). The real and imaginary tone likelihood metrics may then be aggregated to determine the tone likelihood metric. This aggregation may include aggregating the real and imaginary tone likelihood metric for individual frequencies to determine the tone likelihood metric for the individual frequencies. To perform this aggregation, tone likelihood module 20 may include one or more of a logarithm sub-module (not shown), an aggregation sub-module (not shown), and/or other sub-modules.

The logarithm sub-module may be configured to take the logarithm (e.g., the natural logarithm) of the real and imaginary tone likelihood metrics. This may result in determination of the logarithm of each of the real tone likelihood metric and the imaginary tone likelihood metric as a function of frequency. The aggregation sub-module may be configured to sum the real tone likelihood metric and the imaginary tone likelihood metric for common frequencies (e.g., summing the real tone likelihood metric and the imaginary tone likelihood metric for a given frequency) to aggregate the real and imaginary tone likelihood metrics. This aggregation may be implemented as the tone likelihood metric, the exponential function of the aggregated values may be taken for implementation as the tone likelihood metric, and/or other processing may be performed on the aggregation prior to implementation as the tone likelihood metric.

The pitch likelihood module 22 may be configured to determine, based on the determination of tone likelihood metrics by tone likelihood module 20, a pitch likelihood metric as a function of pitch for the audio signal within the time sample window. The pitch likelihood metric for a given pitch may be related to the likelihood that a sound represented by the audio signal has the given pitch during the time sample window. The pitch likelihood module 22 may be configured to determine the pitch likelihood metric for a given pitch by aggregating the tone likelihood metric determined for the tones that correspond to the harmonics of the given pitch.

By way of illustration, referring back to FIG. 3, for a pitch ϕₖ, the pitch likelihood metric may be determined by aggregating the tone likelihood metric at the frequencies at which harmonics of a sound having a pitch of ϕₖ would be expected. To determine pitch likelihood metric as a function of pitch, ϕₖ may be incremented between an initial pitch ϕ₀, and a final pitch ϕₙ. The initial pitch, the final pitch, the increment between pitches, and/or other parameters of this determination may be fixed, set based on user input, tune (e.g., automatically and/or manually) based on the desired resolution for the pitch estimate, the range of anticipated pitch values, and/or set in other ways.

Returning to FIG. 1, in order to aggregate the tone likelihood metric to determine the pitch likelihood metric, pitch likelihood module 22 may include one or more of a logarithm sub-module, an aggregation sub-module, and/or other sub-modules.

The logarithm sub-module may be configured to take the logarithm (e.g., the natural logarithm) of the tone likelihood metrics. In implementations in which tone likelihood module 20 generates the tone likelihood metric in logarithm form (e.g., as discussed above), pitch likelihood module 22 may be implemented without the logarithm sub-module. The aggregation sub-module may be configured to sum, for each pitch (e.g., ϕₖ, for k=0 through n) the logarithms of the tone likelihood metric for the frequencies at which harmonics of the pitch would be expected (e.g., as represented in FIG. 3 and discussed above). These aggregations may then be implemented as the pitch likelihood metric for the pitches.

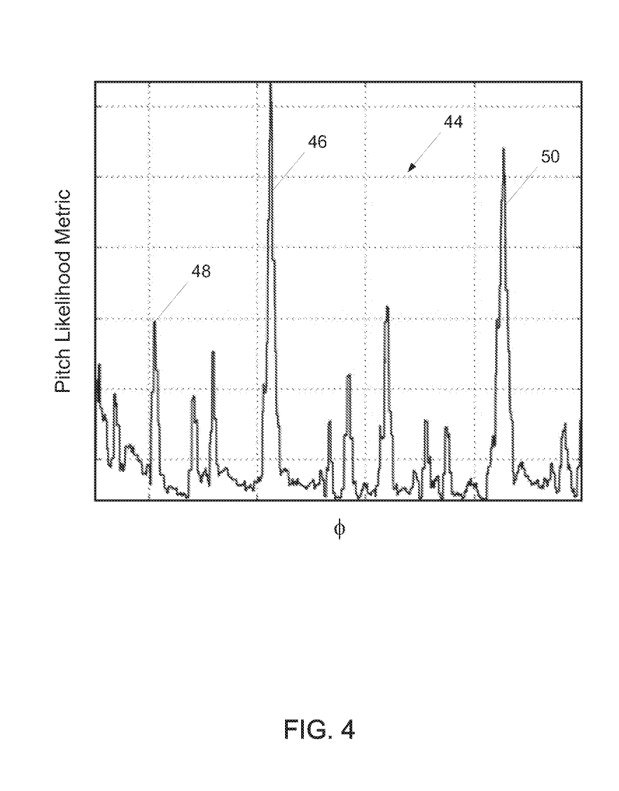

Operation of pitch likelihood module 22 may result in a representation of the data that expresses the pitch likelihood metric as a function of pitch. By way of illustration, FIG. 4 depicts a plot 44 of pitch likelihood metric as a function of pitch for the audio signal within the time sample window. As can be seen in FIG. 4, at a pitch represented in the transformed audio information within the time sample window, a global maximum 46 in pitch likelihood metric may develop. Typically, because of the harmonic nature of pitch, local maxima may also develop at half the pitch of the sound (e.g., maximum 48 in FIG. 4) and/or twice the pitch of the sound (e.g., maximum 50 in FIG. 4).

Returning to FIG. 1, estimated pitch module 24 may be configured to determine an estimated pitch of a sound represented in the audio signal within the time sample window based on the pitch likelihood metric. Determining an estimated pitch of a sound represented in the audio signal within the time sample window based on the pitch likelihood metric may include identifying a pitch for which the pitch likelihood metric is a maximum (e.g., a global maximum). The technique implemented to identify the pitch for which the pitch likelihood metric is a maximum may include a standard maximum likelihood estimation.

As was mentioned above, in some implementations, the transformed audio information may have been transformed to the frequency-chirp domain. In such implementations, the transformed audio information may be viewed as a plurality of sets of transformed audio information that correspond to separate fractional chirp rates (e.g., separate one-dimensional slices through the two-dimensional frequency-chirp domain, each one-dimensional slice corresponding to a different fractional chirp rate). These sets of transformed audio information may be processed separately by modules 20 and/or 22, and then recombined into a space parameterized by pitch, pitch likelihood metric, and fractional chirp rate. Within this space, estimated pitch module 24 may be configured to determine an estimated pitch and an estimated fractional chirp rate, as the magnitude of the pitch likelihood metric may exhibit a maximum not only along the pitch parameter, but also along the fractional chirp rate parameter.

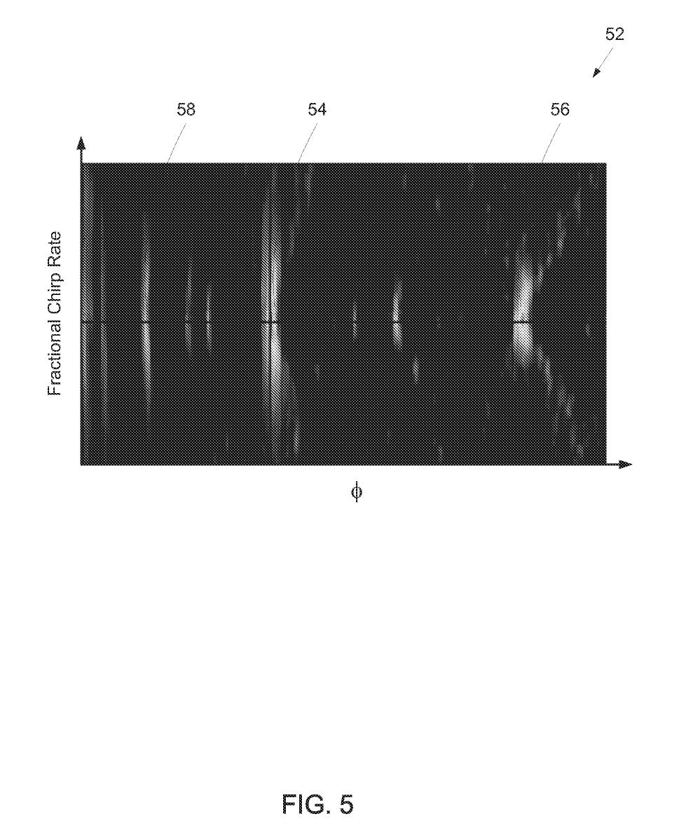

By way of illustration, FIG. 5 shows a space 52 in which pitch likelihood metric may be defined as a function pitch and fractional chirp rate. In FIG. 5, magnitude of pitch likelihood metric may be depicted by shade (e.g., lighter=greater magnitude). As can be seen, maxima for the pitch likelihood metric may be two-dimensional local maxima over pitch and fractional chirp rate. The maxima may include a local maximum 54 at the pitch of a sound represented in the audio signal within the time sample window, a local maximum 56 at twice the pitch, a local maximum 58 at half the pitch, and/or other local maxima.

Returning to FIG. 1, in some implementations, estimated pitch module 24 may be configured to determine the estimated fractional chirp rate based on the pitch likelihood metric alone (e.g., identifying a maximum in pitch likelihood metric for some fractional chirp rate at the pitch). In some implementations, estimated pitch module 24 may be configured to determine the estimated fractional chirp rate by aggregating pitch likelihood metric along common fractional chirp rates. This may include, for example, summing pitch likelihood metrics (or natural logarithms thereof) along individual fractional chirp rates, and then comparing these aggregations to identify a maximum. This aggregated metric may be referred to as a chirp likelihood metric, an aggregated pitch likelihood metric, and/or referred to by other names.

Processor 12 may be configured to provide information processing capabilities in system 10. As such, processor 12 may include one or more of a digital processor, an analog processor, a digital circuit designed to process information, an analog circuit designed to process information, a state machine, and/or other mechanisms for electronically processing information. Although processor 12 is shown in FIG. 1 as a single entity, this is for illustrative purposes only. In some implementations, processor 12 may include a plurality of processing units. These processing units may be physically located within the same device, or processor 12 may represent processing functionality of a plurality of devices operating in coordination (e.g., “in the cloud”, and/or other virtualized processing solutions).

It should be appreciated that although modules 18, 20, 22, and 24 are illustrated in FIG. 1 as being co-located within a single processing unit, in implementations in which processor 12 includes multiple processing units, one or more of modules 18, 20, 22, and/or 24 may be located remotely from the other modules. The description of the functionality provided by the different modules 18, 20, 22, and/or 24 described below is for illustrative purposes, and is not intended to be limiting, as any of modules 18, 20, 22, and/or 24 may provide more or less functionality than is described. For example, one or more of modules 18, 20, 22, and/or 24 may be eliminated, and some or all of its functionality may be provided by other ones of modules 18, 20, 22, and/or 24. As another example, processor 12 may be configured to execute one or more additional modules that may perform some or all of the functionality attributed below to one of modules 18, 20, 22, and/or 24.

Electronic storage 14 may comprise electronic storage media that stores information. The electronic storage media of electronic storage 14 may include one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.).

Electronic storage 14 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 14 may include virtual storage resources, such as storage resources provided via a cloud and/or a virtual private network. Electronic storage 14 may store software algorithms, information determined by processor 12, information received via user interface 16, and/or other information that enables system 10 to function properly. Electronic storage 14 may be a separate component within system 10, or electronic storage 14 may be provided integrally with one or more other components of system 10 (e.g., processor 12).

User interface 16 may be configured to provide an interface between system 10 and users. This may enable data, results, and/or instructions and any other communicable items, collectively referred to as “information,” to be communicated between the users and system 10. Examples of interface devices suitable for inclusion in user interface 16 include a keypad, buttons, switches, a keyboard, knobs, levers, a display screen, a touch screen, speakers, a microphone, an indicator light, an audible alarm, and a printer. It is to be understood that other communication techniques, either hard-wired or wireless, are also contemplated by the present invention as user interface 16. For example, the present invention contemplates that user interface 16 may be integrated with a removable storage interface provided by electronic storage 14. In this example, information may be loaded into system 10 from removable storage (e.g., a smart card, a flash drive, a removable disk, etc.) that enables the user(s) to customize the implementation of system 10. Other exemplary input devices and techniques adapted for use with system 10 as user interface 14 include, but are not limited to, an RS-232 port, RF link, an IR link, modem (telephone, cable or other). In short, any technique for communicating information with system 10 is contemplated by the present invention as user interface 14.

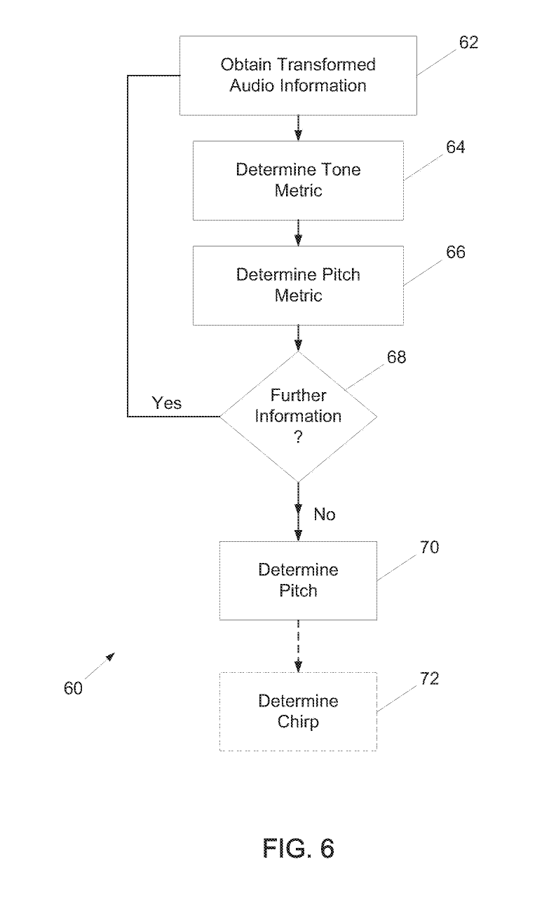

FIG. 6 illustrates a method 60 of analyzing audio information. The operations of method 60 presented below are intended to be illustrative. In some embodiments, method 60 may be accomplished with one or more additional operations not described, and/or without one or more of the operations discussed. Additionally, the order in which the operations of method 60 are illustrated in FIG. 6 and described below is not intended to be limiting.

In some embodiments, method 60 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 60 in response to instructions stored electronically on an electronic storage medium. The one or more processing devices may include one or more devices configured through hardware, firmware, and/or software to be specifically designed for execution of one or more of the operations of method 60.

At an operation 62, transformed audio information representing one or more sounds may be obtained. The transformed audio information may specify magnitude of a coefficient related to signal intensity as a function of frequency for an audio signal within a time sample window. In some implementations, operation 62 may be performed by an audio information module that is the same as or similar to audio information module 18 (shown in FIG. 1 and described above).

At an operation 64, a tone likelihood metric may be determined based on the obtained transformed audio information. This determination may specify the tone likelihood metric as a function of frequency for the audio signal within the time sample window. The tone likelihood metric for a given frequency may indicate the likelihood that a sound represented by the audio signal has a tone at the given frequency during the time sample window. In some implementations, operation 64 may be performed by a tone likelihood module that is the same as or similar to tone likelihood module 20 (shown in FIG. 1 and described above).

At an operation 66, a pitch likelihood metric may be determined based on the tone likelihood metric. Determination of the pitch likelihood metric may specify the pitch likelihood metric as a function of pitch for the audio signal within the time sample window. The pitch likelihood metric for a given pitch may be related to the likelihood that a sound represented by the audio signal has the given pitch. In some implementations, operation 66 may be performed by a pitch likelihood module that is the same as or similar to pitch likelihood module 22 (shown in FIG. 1 and described above).

In some implementations, the transformed audio information may include a plurality of sets of transformed audio information. Individual ones of the sets of transformed audio information may correspond to individual fractional chirp rates. In such implementations, operations 62, 64, and 66 may be iterated for the individual sets of transformed audio information. At an operation 68, a determination may be made as to whether further sets of transformed audio information should be processed. Responsive to a determination that one or more further sets of transformed audio information are to be processed, method 60 may return to operation 62. Responsive to a determination that no further sets of transformed audio information are to be processed (or if the transformed audio information is not divide according to fractional chirp rate), method 60 may proceed to an operation 70. In some implementations, operation 68 may be performed by a processor that is the same as or similar to processor 12 (shown in FIG. 1 and described above).

At operation 70, an estimated pitch of the sound represented in the audio signal during the time sample window may be determined. Determining the estimated pitch may include identifying a pitch for which the pitch likelihood metric has a maximum within the time sample window. In some implementations, operation 70 may be performed by an estimated pitch module that is the same as or similar to estimated pitch module 24 (shown in FIG. 1 and described above).

In implementations in which the transformed audio information includes a plurality of sets of transformed audio information corresponding to different fractional chirp rates, an estimated fractional chirp rate may be determined at an operation 72. Determining the estimated fractional chirp rate may include identifying a maximum in pitch likelihood metric for fractional chirp rate along the estimated pitch determined at operation 70. In some implementations, operations 72 and 70 may be performed in reverse order from the order shown in FIG. 6. In such implementations, the estimated fractional chirp rate based on aggregations of pitch likelihood metric along different fractional chirp rates, and then identifying a maximum in these aggregations. Operation 70 may then be performed based on an analysis of pitch likelihood metric for the estimated fractional chirp rate. In some implementations, operation 72 may be performed by an estimated pitch module that is the same as or similar to estimated pitch module 24 (shown in FIG. 1 and described above).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to analyze audio information, the system comprising:
one or more processors configured to execute computer program modules, the computer program modules comprising:
an audio information module configured to obtain transformed audio information representing one or more sounds, wherein the transformed audio information specifies magnitude of a coefficient related to energy amplitude as a function of frequency for an audio signal within a time sample window; and
a tone likelihood module configured to determine, from the obtained transformed audio information, a tone likelihood metric as a function of frequency for the audio signal within the time sample window, wherein the tone likelihood metric for a given frequency indicates the likelihood that a sound represented by the audio signal has a tone at the given frequency during the time sample window.

2. The system of claim 1, wherein the computer program modules further comprise a pitch likelihood module configured to determine, based on the tone likelihood metric, a pitch likelihood metric as a function of pitch for the audio signal within the time sample window, wherein the pitch likelihood metric for a given pitch is related to the likelihood that a sound represented by the audio signal has the given pitch.

3. The system of claim 2, wherein the pitch likelihood module is configured such that the pitch likelihood metric for the given pitch is determined by aggregating the tone likelihood metric determined for the tones that correspond to the harmonics of the given pitch.

4. The system of claim 3, wherein the pitch likelihood module comprises:
a logarithm sub-module configured to take the logarithm of the tone likelihood metric to determine the logarithm of the tone likelihood metric as a function of frequency; and
a sum sub-module configured to determine the pitch likelihood metric for individual pitches by summing the logarithm of the tone likelihood metrics that correspond to the individual pitches.

5. The system of claim 2, wherein the computer program modules further comprise an estimated pitch module configured to determine an estimated pitch of a sound represented in the audio signal within the time sample window based on the pitch likelihood metric.

6. The system of claim 5, wherein the estimated pitch module is configured such that determining the estimated pitch includes identifying a pitch for which the pitch likelihood metric has a maximum within the time sample window.

7. The system of claim 3, wherein transformed audio information includes a plurality of sets of transformed audio information that correspond to separate fractional chirp rates, wherein the tone likelihood module and the pitch likelihood module are configured such that the pitch likelihood metric is determined separately within the individual sets of transformed audio information to determine the pitch likelihood metric for the audio signal within the time sample window as a function of pitch and fractional chirp rate.

8. The system of claim 7, wherein the computer program modules further comprise an estimated pitch module configured to determine an estimated pitch and an estimated fractional chirp rate, and wherein determining an estimated pitch and an estimated fractional chirp rate comprises identifying a pitch and chirp rate for which the pitch likelihood metric has a maximum within the time sample window.

9. The system of claim 1, wherein the tone likelihood module is configured such that tone likelihood metric for a given frequency is based on a dot product between (i) a peak function having a function width centered on the given frequency and (ii) the transformed audio information over the function width centered on the given frequency.

10. The system of claim 9, wherein the tone likelihood module is configured such that the peak function is a Gaussian function.

11. A method of analyzing transformed audio information, the method comprising:
obtaining transformed audio information representing one or more sounds, wherein the transformed audio information specifies magnitude of a coefficient related to energy amplitude as a function of frequency for an audio signal within a time sample window; and
determining, from the obtained transformed audio information, a tone likelihood metric as a function of frequency for the audio signal within the time sample window, wherein the tone likelihood metric for a given frequency indicates the likelihood that a sound represented by the audio signal has a tone at the given frequency during the time sample window.

12. The method of claim 11, further comprising determining, based on the tone likelihood metric, a pitch likelihood metric as a function of pitch for the audio signal within the time sample window, wherein the pitch likelihood metric for a given pitch is related to the likelihood that a sound represented by the audio signal has the given pitch.

13. The method of claim 12, wherein the pitch likelihood metric for the given pitch is determined by aggregating the tone likelihood metric determined for the tones that correspond to the harmonics of the given pitch.

14. The method of claim 13, wherein determining the pitch likelihood metric comprises:
taking the logarithm of the tone likelihood metric to determine the logarithm of the tone likelihood metric as a function of frequency; and
determining the pitch likelihood metric for individual pitches by summing the logarithm of the tone likelihood metrics that correspond to the individual pitches.

15. The method of claim 12, further comprising determining an estimated pitch of a sound represented in the audio signal within the time sample window based on the pitch likelihood metric.

16. The method of claim 15, wherein determining the estimated pitch includes identifying a pitch for which the pitch likelihood metric has a maximum within the time sample window.

17. The method of claim 13, wherein transformed audio information includes a plurality of sets of transformed audio information that correspond to separate fractional chirp rates, wherein determining the pitch likelihood metric comprises determining the pitch likelihood metric separately within the individual sets of transformed audio information to determine the pitch likelihood metric for the audio signal within the time sample window as a function of pitch and fractional chirp rate.

18. The method of claim 17, further comprising determining an estimated pitch and an estimated fractional chirp rate, and wherein determining an estimated pitch and an estimated fractional chirp rate comprises identifying a pitch and chirp rate for which the pitch likelihood metric has a maximum within the time sample window.

19. The method of claim 11, wherein determination of the tone likelihood metric for a given frequency is based on a dot product between (i) a peak function having a function width centered on the given frequency and (ii) the transformed audio information over the function width centered on the given frequency.

20. The method of claim 19, wherein the tone likelihood module is configured such that the peak function is a Gaussian function.
